(19) United States
(12) Patent Application Publication
(10) Pub. No.: US 2009/0258740 A1
(43) Pub. Date: Oct. 15, 2009

(54) TOOTHED WHEEL AND GROUP OF TOOTHED WHEELS FOR A BICYCLE TRANSMISSION SYSTEM

(75) Inventor: Maurizio Valle, Vicenza (VI) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: CAPAGNOLO S.R.L., Vicenza (IT)

(21) Appl. No.: 12/352,783

(22) Filed: Jan. 13, 2009

(30) Foreign Application Priority Data
Apr. 10, 2008 (EP) 08425244.4

(51) Int. Cl. B62M 9/12

(52) U.S. Cl. 474/160

(57) ABSTRACT

A toothed wheel for a chain transmission system for a bicycle, intended to be coupled with at least one other toothed wheel in a group of crowns or of sprockets rotating as a unit has a plurality of teeth that follow one another on the radially outer periphery of the toothed wheel, alternating with grooves. Each tooth has a thickness, a width and a height and has an idle flank, passive in the exchange of torque with a bicycle chain, and a pressure flank, active in the exchange of torque with the same chain. The toothed wheel has at least one gearshifting helping tooth the height of which, measured from the bottom of an adjacent groove, decreases in the direction of the pressure flank, in any case being greater than or equal to 90% of the radius of the pin.

### FIELD OF INVENTION

The field refers to a toothed wheel of a chain transmission system for a bicycle and to a group of toothed wheels for front and rear bicycle gearshifts.

### BACKGROUND

As used herein, the term “sprockets” identifies the toothed wheels of a transmission system for bicycles intended to be coupled with the rear wheel, and the term “crowns” identifies the toothed wheels intended to be coupled with the cranks.

Bicycle transmission systems have a group of sprockets having different diameters, mounted together and rotating as a unit, on which the transmission chain is engaged, alternately on one of the sprockets of the group according to the transmission ratio to be accomplished. On each sprocket of the group the teeth follow one another at constant distance, or pitch, alternating with grooves; the pitch is equal on the various wheels of the same group of sprockets and corresponds to the pitch of the chain. The chain is run into rotation by the cyclist through the pedals and the front toothed wheels, or crowns, of the bicycle.

Normally, on a bicycle the transmission of motion always takes place the same way, i.e. the chain always has the same rotational motion (at least when it transmits power/torque), and therefore the front crowns and the sprockets always have the same direction of rotation. In other words, the direction of movement of the teeth of the crowns and of the sprockets is always the same. With reference to such a direction of rotation, every tooth has a preceding flank (the one facing forwards with respect to the direction of rotation) and a following flank (the one facing backwards). In front crowns the pressure flank, on which acts the traction force exerted by the chain, is the preceding one; in wheels of a rear gearshift group, the pressure flank is the following one. The flank of a tooth opposite the pressure flank is defined as the idle flank and it does not cooperate with the transmission of torque. In front crowns the idle flank of each tooth is the one following the tooth itself with respect to the direction of rotation of the crown. In rear sprockets, the idle flank of each tooth is the one preceding the tooth itself with respect to the direction of rotation of the sprocket. In general, every tooth also has an extension in the circumferential direction, or width, an extension in the radial direction, or height, and an extension in the axial direction, or thickness.

The movement of the chain disengaging one sprocket and engaging another adjacent sprocket, or else the movement from a first crown to a second front crown, is known as “gearshifting,” and is normally obtained by moving the chain transversally with respect to its own longitudinal axis (i.e. axially with respect to the toothed wheel), until it abandons the engagement with one toothed wheel and moves towards the engagement with the adjacent toothed wheel. This movement action is normally obtained with chain guide devices, operated by the cyclist.

If gearshifting occurs starting from a wheel having a larger diameter towards a wheel having a smaller diameter, it is defined as “downward gearshifting;” vice-versa, if it occurs starting from a wheel having a smaller diameter towards a wheel having a larger diameter, it is defined as “upward gearshifting.” As known, upward gearshifting on the rear sprockets causes a reduction in the transmission ratio, and vice-versa, downward gearshifting causes an increase in such a ratio. Gearshifting, both upward and downward, is in any case a delicate transition operation, since it occurs when the chain is under tension and since the chain has very limited deformability in the transversal direction (with respect to its longitudinal axis).

The gearshifting steps alternate with the normal operation steps in which the chain engages a single sprocket and a single crown to transmit the torque.

Current toothed wheels have certain drawbacks that do not allow a regular transition of the transmission ration upward gearshifting.

### SUMMARY

A toothed wheel for a chain transmission system for a bicycle, intended to be coupled with at least one other toothed wheel in a group of toothed wheels rotating as a unit, has a plurality of teeth that follow one another on the radially outer periphery of the toothed wheel, alternating with grooves, wherein each tooth has a thickness, a width and a height and has an idle flank, passive in the transmission of torque with a bicycle chain, and a pressure flank, active in the transmission of torque with the same chain, in which the pressure flank, which extends in the circumferential direction, is concave for the engagement with a pin of the chain, comprising at least one tooth for helping gearshifting the height of which, measured from the bottom of an adjacent groove, decreases in the direction of the pressure flank, in any case being greater than or equal to 90% of the radius of the pin.

### BRIEF DESCRIPTION OF THE DRAWING(S)

Further characteristics shall become clearer from the following description, made with reference to the attached drawings. In such drawings:

FIGS. 1, 2 and 3 are respective front, plan, and rear views of a circular sector of a sprocket and of a group of sprockets;

FIGS. 4, 5 and 6 are respective front, plan, and rear views of a first detail of the group of sprockets shown in FIG. 1;

FIG. 7 is a plan view of a chain suitable for engaging a group of sprockets;

FIGS. 8 and 9 are respective front and rear views of a second detail of the group of sprockets shown in FIG. 1;

FIGS. 10, 11 and 12 are respective front, plan, and rear views of further details of the group of sprockets shown in FIG. 1;

FIGS. 13, 14 and 15 are respective front, plan, and rear views of a circular sector of a sprocket and of a group of sprockets, during an upward gearshifting step, in a first configuration;

FIG. 16 is an enlarged view of a detail of FIG. 14;

FIGS. 17, 18, and 19 are respective front, plan and rear views of a circular sector of a sprocket and of a group of sprockets, during an upward gearshifting step, in a second configuration; and

FIG. 20 is an enlarged view of a detail of FIG. 18.

### DETAILED DESCRIPTION OF THE EMBODIMENTS INTRODUCTION

The height of the tooth for helping gearshifting gradually reduces at the pressure flank of the tooth. In a sprocket, the pressure flank of each tooth is the flank following the tooth itself with respect to the direction of rotation of the sprocket. In a crown, the pressure flank is the one preceding the tooth with respect to the direction of rotation. This characteristic allows upward gearshifting to be accomplished easier, i.e. it simplifies the movement of the transmission chain towards the engagement with the sprocket or the crown having larger diameter, at the same time ensuring an optimal transmission of torque during normal operation, i.e. before and after gearshifting, without risks of disengagement of the chain.

In an embodiment of the toothed wheel, the gearshifting helping tooth also comprises a top face, preferably convex, which extends in the circumferential direction between an edge, or a vertex, having the maximum height and an edge, or a joining surface with the pressure flank, having the minimum height. In other words the top face of the tooth for helping gearshifting has a substantially circumferential extension, but slightly decreasing towards the pressure flank of the tooth. In this circumstance, the minimum height of the tooth for helping gearshifting, i.e. the height between the bottom of the groove adjacent to the pressure flank and the join between the top face and the pressure flank, is greater than or equal to 90% of the radius of the pin of the chain.

The tooth for helping gearshifting also has an outer face perpendicular to the axis of the toothed wheel and intended to face towards the toothed wheel having smaller diameter. The outer face, with the idle flank of the same helping tooth, forms a hooking and radial lifting edge of the transmission chain. This edge has the function of causing the chain to lift towards the top face of the tooth when, during the gearshifting step commanded by the cyclist, a component of the chain interacts with the same lifting edge. In simpler terms, the hooking (and lifting) edge pulls the chain during gearshifting and is also configured like an upward ramp that pushes the transmission chain beyond the top face of the tooth, facilitating the movement of the chain towards the engagement with the toothed wheel having larger diameter.

The hooking edge intersects the top face of the tooth at a vertex of the idle flank, this being the vertex that constitutes the point of the tooth having maximum height. Therefore, the gearshifting helping tooth has maximum height, measured with respect to the bottom of the groove adjacent to the pressure flank, at the intersection between the idle flank, the top face and the outer face.

Preferably, the minimum height of the gearshifting helping tooth, measured between the bottom of the groove adjacent to the pressure flank, and the join between the top face and the pressure flank, is greater than or equal to ⅔ of the maximum height of the same tooth, measured between the bottom of the same groove and the vertex of the idle flank. This geometric relationship allows optimal functionality of the gearshifting helping tooth in terms of the transmission of torque during normal operation and the movement of the chain during gearshifting.

According to a particularly effective embodiment of the sprocket, the gearshifting helping tooth also comprises a first bevel formed on the outer face, between the top face and the pressure flank. The depth of the first bevel, with respect to the outer face, increases towards the pressure flank, and is at its maximum at the join between the pressure flank and the top face. The bevel can be flat, but preferably it is defined by a concave surface.

On the inner face of the gearshifting helping tooth, i.e. on the face normally tapered in the radial direction and opposite the outer face, a second bevel is formed. The second bevel extends up to the vertex formed by the intersection between the inner face, the top face and the idle flank. Preferably, the second bevel is defined by a flat triangular surface.

On the taper of the inner face of the gearshifting helping tooth a third bevel is preferably formed that extends until it intersects the pressure flank. In this circumstance, the second bevel and the third bevel intersect one another and both intersect the taper of the inner face and the top face, which however do not intersect one another.

Preferably, the gearshifting helping tooth is next, on the side of the idle flank, to a depressed tooth the maximum height of which is lower than the maximum height of the remaining teeth of the toothed wheel (including the gearshifting helping tooth) and the highest portion of which is proximal to the gearshifting helping tooth.

According to the preferred embodiment, the toothed wheel described above is a sprocket.

In another embodiment, a group of toothed wheels are used in a bicycle chain transmission system.

In particular, the group of toothed wheels comprises at least one toothed wheel having a smaller diameter and at least one toothed wheel having a larger diameter, fixed with respect to each other and rotatable around a common axis, intended to be selectively engaged by a transmission chain, wherein the toothed wheels comprise, on its own periphery, a plurality of teeth arranged circumferentially and alternating with grooves at a constant pitch, each tooth having a thickness, a width and a height and having an idle flank, passive in the transmission of torque with a bicycle chain, and a pressure flank, active in the transmission of torque with the same chain, wherein the toothed wheel having a larger diameter comprises at least one hooking tooth of the transmission chain, suitable for engaging and holding a portion of the transmission chain that, during gearshifting, extends between the toothed wheel having a smaller diameter and the toothed wheel having a larger diameter in a circular sector of the group of toothed wheels, defined as gearshifting sector, and wherein in the gearshifting sector, the distance D between the center of a groove between two consecutive teeth of the toothed wheel having smaller diameter and the center of a groove between two consecutive teeth of the toothed wheel having larger diameter is within the range:

0.85·N·P≦D≦N·P,

in which N is an integer number and P is the pitch (The pitch is the distance between a center of two consecutive grooves or teeth of a toothed wheel,) of the group of toothed wheels.

At least in the gearshifting sector, the pressure flanks of the teeth, i.e. the flanks intended to interact with a pin of the chain for the transmission of torque, have a portion that has, on a plane perpendicular to the axis of the toothed wheel, a circular profile. For the purposes, the center of a groove is defined as the center of curvature of the pressure flank of the tooth adjacent to the groove itself.

At least one of the toothed wheels is a wheel as described below or where N=2 and the toothed wheel having larger diameter has one extra tooth compared to the toothed wheel having smaller diameter.

The group of toothed wheels has several features compared to conventional solutions. First, the transmission chain is carried on the side of the wheel having larger diameter, i.e. it is moved axially for the engagement with the toothed wheel having larger diameter, in the smallest possible groove, in practice in the groove of two links of the chain. Second, the angular phase displacement between the homologous teeth of the gearshifting sector of the wheels of the group, a phase displacement that depends upon the distance D indicated above, allows the teeth of the toothed wheel having larger diameter to quickly engage the transmission chain, without the group idling.

The transmission chain is formed by a succession of inner links alternating with outer links. Each outer link consists of a pair of opposite plates facing each other at distance, hinged at their ends, at the inner faces, to a pair of plates that constitute the inner links. The inner links define a gap smaller than the one defined by the outer links, but still sufficient to house a tooth of a toothed wheel. The plates that constitute the inner links are kept separated apart thanks to pins that, during operation, go into abutment on the pressure flanks of the teeth of the wheels.

The group of toothed wheels is effective in both cases in which upward gearshifting occurs at an outer link of the chain, or else occurs at an inner link. “Outer link gearshifting” means upward gearshifting in which the first link to undergo a radial lifting with respect to the toothed wheel having smaller diameter, and therefore the first link to disengage the relative tooth, is an outer link. Vice-versa, by the expression “inner link gearshifting” we mean upward gearshifting in which the first link to lift from the toothed wheel having smaller diameter is an inner link of the chain.

Hereafter, the characteristics of the group of toothed wheels that mainly simplify outer link upward gearshifting shall be described.

At least in the gearshifting sector, the toothed wheel having smaller diameter comprises at least one gearshifting helping tooth the height of which, measured from the bottom of the groove adjacent to the pressure flank, decreases in the direction of the pressure flank itself. The height of the gearshifting helping tooth is greater than or equal to 90% the radius of the pin of the transmission chain.

The gearshifting helping tooth may comprise a convex top face, which extends in the circumferential direction between an edge, or a vertex, having maximum height and an edge, or a joining surface with the pressure flank of the same tooth, having minimum height.

In the circumstance in which the gearshifting helping tooth has a top surface, the minimum height is measured between the bottom of the groove adjacent to the pressure flank of the tooth itself and the intersection of the top surface with the pressure flank. Such a minimum height is in any case greater than or equal to 90% of the radius of the pin of the transmission chain.

The hooking tooth also may comprise an outer face perpendicular to the axis of the toothed wheels and facing towards the toothed wheel having smaller diameter. The outer face forms, with the idle flank of the tooth, a hooking edge of the transmission chain.

The hooking tooth may also comprise a first bevel formed on the outer face, between the top face and the pressure flank. The depth of the first bevel, with respect to the outer face, increases towards the pressure flank and is at its maximum at the join, or the edge, between the pressure flank and the top face. The first bevel may be defined by a concave surface.

The maximum height of the gearshifting helping tooth, measured with respect to the bottom of the groove adjacent to the pressure flank of the same tooth, is located at the intersection between the idle flank and the top face. The minimum height of the gearshifting helping tooth, measured from the bottom of the aforementioned groove, is greater than or equal to ⅔ of the maximum height of the same helping tooth.

The mutual angular positioning of the wheels may be selected so that, in the gearshifting sector, the hooking tooth of the toothed wheel having larger diameter is adjacent to the idle flank of the gearshifting helping tooth of the toothed wheel having smaller diameter.

The hooking tooth of the toothed wheel having larger diameter may be identical to the gearshifting helping tooth of the toothed wheel having smaller diameter.

The gearshifting helping tooth may also comprise an inner face, perpendicular to the axis of the toothed wheels and facing towards the toothed wheel having larger diameter. The inner face is tapered in the radial direction and has a second bevel that extends up to the idle vertex formed by the intersection between the inner face, the top face and the idle flank of the tooth. More preferably, the second bevel is defined by a flat triangular surface.

Hereafter, the characteristics of the group of toothed wheels that mainly simplify inner link upward gearshifting shall be described. Such characteristics can be present on the wheels independently from, or in combination with, the characteristics that promote outer link upward gearshifting.

In order to optimize inner link gearshifting, the toothed wheel having smaller diameter comprises a depressed tooth the maximum height of which is lower than the maximum height of the remaining teeth of the same toothed wheel. The tooth having lower height, i.e. the depressed tooth, allows the chain to pass from one toothed wheel to the other without undergoing excessive stretching along the way that leads to the same depressed tooth being passed over. In this way the chain goes onto the toothed wheel having larger diameter in phase to engage its teeth.

The depressed tooth is beside the idle flank of the gearshifting helping tooth. The highest portion of the depressed tooth is adjacent, i.e. proximal, to the gearshifting helping tooth, so as to be able to effectively engage the chain during normal operation.

On the aforementioned taper of the gearshifting helping tooth a third bevel is formed that extends until it intersects the pressure flank of the same tooth. The second bevel and the third bevel intersect one another and intersect the taper and the top face, which do not intersect one another.

According to an embodiment of the group of toothed wheels, the distance D is calculated between the center of the groove adjacent to the idle flank of the hooking tooth of the toothed wheel having larger diameter and the center of the groove adjacent to the idle flank of the depressed tooth of the toothed wheel having smaller diameter.

The tooth adjacent to the idle flank of the hooking tooth of the toothed wheel having larger diameter may be provided with a narrowing at the outer face, orientated perpendicular to the rotation axis and facing towards the toothed wheel having smaller diameter.

According to an embodiment, the toothed wheels of the group of wheels are sprockets.

### DESCRIPTION

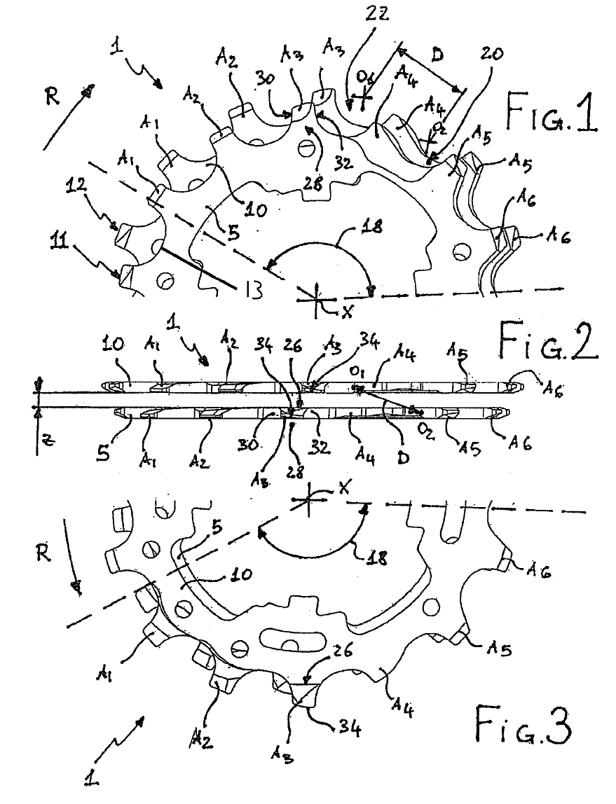

With reference to FIGS. 1, 2 and 3, a group of toothed wheels 1 is shown. In general, the toothed wheels of the group 1 can be front crowns or rear sprockets of a bicycle. In particular, FIGS. 1-20 show a group 1 of sprockets 5, 10. It should be understood that the characteristics described in relation to the sprockets 5, 10 are in principle also applicable to crowns of bicycles.

The group 1 comprises at least one sprocket 5 having smaller diameter and at least one sprocket 10 having larger diameter arranged side-by-side along a common rotation axis X. In general, the group 1 can also comprise a larger number of sprockets, for example 5-7 sprockets, or even more, according to the final applications or the preferences of the user.

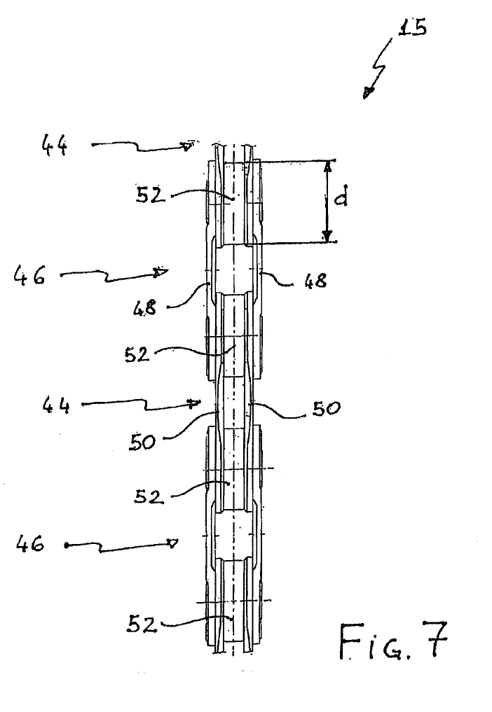

The sprockets 5 and 10 each comprise a succession of teeth 11 and 12 arranged on the radially outer periphery, alternating with grooves 13, for the functional engagement with a transmission chain 15 (FIG. 7). In general, the number of teeth 11 of the sprocket having smaller diameter 5 is less than the number of teeth 12 of the sprocket having larger diameter 10. Preferably, the sprocket having larger diameter 10 comprises an extra tooth compared to the sprocket having smaller diameter 5.

According to one embodiment, shown in FIGS. 1-3, the teeth 12 of the sprocket having larger diameter 10 have an identical configuration to corresponding teeth 11 of the sprocket having smaller diameter 5, i.e. the “homologous” teeth of the sprocket 5. The pitch P between the consecutive teeth 11 and 12 in the two sprockets 5 and 10 is the same, and is equal to the pitch of the transmission chain 15.

Each sprocket 5 or 10 of the group 1 comprises an upward “gearshifting sector” 18 at which, during gearshifting, the chain 15 extends between the sprocket having larger diameter 10 and the sprocket having smaller diameter 5. In the gearshifting sector 18 there are specialized teeth A1-A6, specially shaped to simplify and promote gearshifting, i.e. to optimize the passage of the chain 15 from the sprocket having smaller diameter 5 to the sprocket having larger diameter 10. Generally, the teeth of the sector 18 are referred to as “specialized” teeth for upward gearshifting.

Conventionally, the gearshifting sector 18 of each sprocket 5, 10 is defined by the first specialized tooth A1 and by the last specialized tooth A6. The gearshifting sector 18 of the entire group 1 of sprockets is defined by the first specialized tooth A1 and by the last specialized tooth A6, whether they belong to the sprocket 5 or to the sprocket 10. FIGS. 1 and 3 show the limits of the gearshifting sector 18 of the group 1 of sprockets. In practice, the gearshifting sector 18 is inside a circular sector of both of the sprockets 5 and 10. “Gearshifting sector” refers to the gearshifting sector of the group 1 of sprockets.

In the gearshifting sector 18, the crowns of teeth 11 and 12 of the sprockets 5, 10 comprise, in succession, the specialized teeth A1, A2, A3, A4, A5, A6. FIGS. 1 and 3 show the form of such a series in a front view, i.e. from the side of the sprocket 5, and rear view, i.e. from the side of the sprocket 10. The teeth A1-A6 of the sprocket 5 are identical to the teeth A1-A6, respectively, of the sprocket 10.

The phasing between the teeth A1-A6 of the sprocket having a smaller diameter 5 and the teeth A1-A6 of the sprocket having a larger diameter 10, i.e. the angular phase displacement between the homologous teeth A1-A1, A2-A2, A3-A3, A4-A4, A5-A5, A6-A6 of the two sprockets 5, 10 in the gearshifting sector 18, must not exceed a certain limit, expressed in terms of the distance D between a groove of the sprocket 5 and a groove of the sprocket 10. In particular, the center of a groove is defined as center of curvature O1, O2, etc. (FIG. 1) of the circular portion of the pressure flank 30 of the tooth preceding that groove with respect to the direction R of rotation. The distance D between the center of curvature of a groove 20 between two consecutive teeth of the sprocket having smaller diameter 5 and the center of curvature of a groove 22 between two consecutive teeth of the sprocket having larger diameter 10, in the gearshifting sector 18 of the group 1, must satisfy the following relationship:

0.85·N·P≦D≦N·P,

where N is an integer number and P is the pitch of the group of sprockets 1. Preferably 0.85·N·P≦D≦0.95 N·P. Even more preferably N=2.

In the embodiment shown in FIGS. 1-3, the grooves 20 and 22 between which the distance D is measured are those between the teeth A3 and A4 of the sprocket having larger diameter 10 and the teeth A4 and A5 of the sprocket having smaller diameter 5.

Considering the case in which the toothed wheels 5 and 10 are crowns, the center of a groove is defined as the center of curvature 13 of the circular portion of the pressure flank of the tooth following that groove with respect to the direction of rotation. Indeed, in the crowns the pressure flank is the flank preceding the tooth, and the idle flank is the one following the tooth with respect to the direction of rotation.

The distance Z (indicated in FIG. 2) between the sprockets 5 and 10, in the axial direction, is preferably less than 2.3 mm, more preferably less than 2 mm.

The following description refers in detail to the shape of the teeth of a sprocket 5 or 10. With reference to the rotation axis X and to the direction of rotation R, common to the two sprockets 5, 10, each tooth 11 or 12 is defined by an inner face 26, orientated axially and facing towards the inside of the bicycle frame (visible in FIG. 3), an outer face 28, orientated axially and facing towards the outside of the bicycle (visible in FIG. 1), a following flank 30, orientated in the circumferential direction and following the tooth during the rotation of the sprocket 5 or 10 (on the left of each tooth in FIG. 1), a preceding flank 32 opposite the following flank (on the right of each tooth in FIG. 1), and a top face 34 orientated in the radial direction (visible in FIG. 2).

The specialized teeth of each sprocket 5 or 10 that allow gearshifting are the teeth A3 and A4, whereas the teeth A1, A2, A5 and A6 are auxiliary teeth, which cooperate with the teeth A3 and A4 to optimize gearshifting. In particular, the tooth A3 of the sprocket having smaller diameter 5 is the gearshifting helping tooth; the tooth A3 of the sprocket having larger diameter 10 is the hooking tooth of the transmission chain 15. The tooth A4, in both of the sprockets 5 and 10, is the depressed tooth.

With particular reference to FIG. 3, the teeth A5 and A6, identical to one another, are asymmetrical teeth, offset in the circumferential direction. During upward gearshifting, the teeth A5 and A6 of the sprocket having smaller diameter 5 allow the chain 15, which is in a position not aligned with the sprockets 5, 10, to leave the sprocket 5 without jamming.

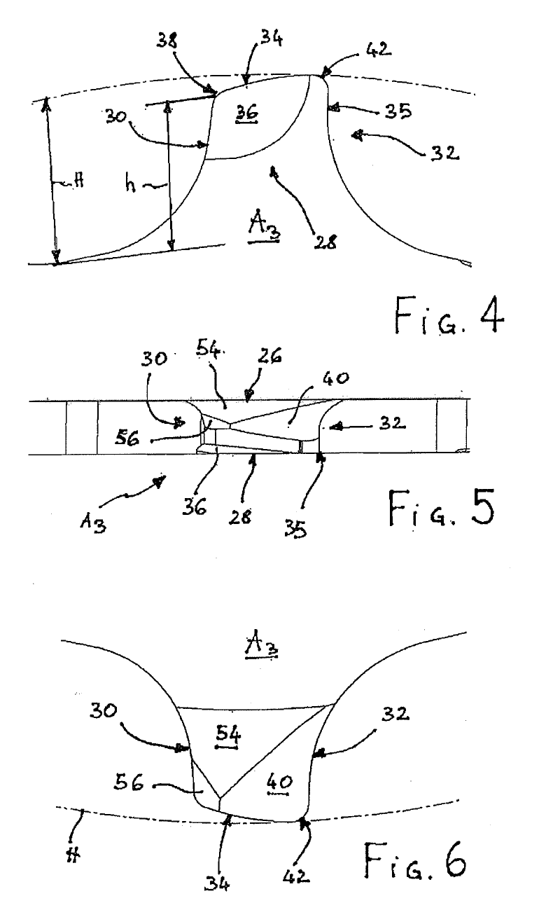

With reference to FIGS. 4, 5 and 6, which respectively show a front, plan and rear view of a helping tooth A3 of the upward gearshifting sector 18 of the group of sprockets 1, the teeth A3 have maximum height H equal to the height of the other teeth 11, 12, however the height of the teeth A3 decreases in the direction of the following flank 30. Advantageously, the height of each tooth A3, measured from the bottom 13 of the following groove, decreases in the direction of the following flank 30, always being greater than or equal to 90% of the radius of the pin 52 of the chain 15.

The tooth A3 has maximum height H at the intersection between the preceding flank 32 and the top face 34. The top face 34 is convex and joins to the following flank 30 in a non-tangent manner, i.e. with a sharp edge or with a small radius of curvature. In particular, the substantially radial extension of the following flank 30 opposes the substantially circumferential extension of the face 34. This characteristic allows the following flank 30 to be made with a height sufficient to support in abutment a pin 52 of the chain 15, which during normal operation of the bicycle transmission transmits torque.

FIG. 7 is a plan view of a standard chain 15, suitable for engaging the group of sprockets 1, which comprises inner links 44 alternating with outer links 46. Each outer link 46 consists of a pair of interfacing plates 48 that are grooved apart, connected at their ends and on the inner faces to a pair of plates 50. The plates 50 form the inner links 44. The distance between centers between the links 44 is less than the distance between centers between the outer links 46, but sufficient to house a tooth 11 and 12 of a sprocket 5, 10. The plates 48 and 50 are kept distant apart by pins 52, which during normal operation of the transmission go into abutment against the teeth 11, 12 pulling them into rotation or being pulled by them into rotation. The diameter d of the pins 52 is standard and can therefore be taken as reference to calculate the height of the tooth A3.

In particular, the minimum height h of the tooth A3 for helping gearshifting, measured between the bottom of the following groove and the edge or the join 38 between the following flank 30 and the top face 34, is greater than or equal to 0.9·(d/2), i.e. it is greater than or equal to 90% of the radius of the pin 52. More preferably h≧(⅔·H), i.e. the minimum height h is greater than or equal to ⅔ of the maximum height H of the tooth A3, which is the height of the preceding vertex 42.

Referring once again to FIGS. 4, 5 and 6, the tooth A3 for helping gearshifting comprises an edge 35 having the function of lifting the chain 15 in the radial direction in the gearshifting step. During gearshifting, i.e. when the chain 15 is shifted with respect to the sprocket 5, the lifting edge 35, defined by the intersection between the outer face 28 and the preceding flank 32, acts as a ramp for a link of the chain 15, which is lifted towards the top face 34.

The tooth A3 also comprises a first bevel 36, formed on the outer face 28, that extends between the following vertex 38, defined by the intersection between the outer face 28, the top face 34 and the following flank 30. The depth of the first bevel 36 increases proceeding from the outer face 28 towards the following vertex 38. Preferably, the first bevel 36 is defined by a concave surface.

The tooth A3 may also comprise a second bevel 40, formed on the inner face 26, that extends between a taper 54 and the preceding vertex 42 formed by the intersection between the inner face 26, the top face 34 and the preceding flank 32. The second bevel 40 may be defined by a substantially triangular flat surface. The taper 54 extends in the radial direction and positively contributes to the engagement of the chain 15 in normal operation.

Further a third bevel 56, for example triangular, may be formed on the inner face 26 between the taper 54, the second bevel 40, and the following flank 30.

As shown in detail in FIGS. 5 and 6, the bevels 40 and 56 join together before reaching the top face 34. The bevels 40 and 56 globally thin out the most radially outer part of the tooth A3 on the side of the inner face 26, avoiding an excessive reduction of the central body of the tooth A3. Alternatively, the bevels 56 and 40 can also be made as a single bevel that is deeper at the following and preceding vertices of the tooth A3 and less deep at the center of the tooth. The combination of these bevels increases the effectiveness of the tooth A3 while simultaneously reducing its weight.

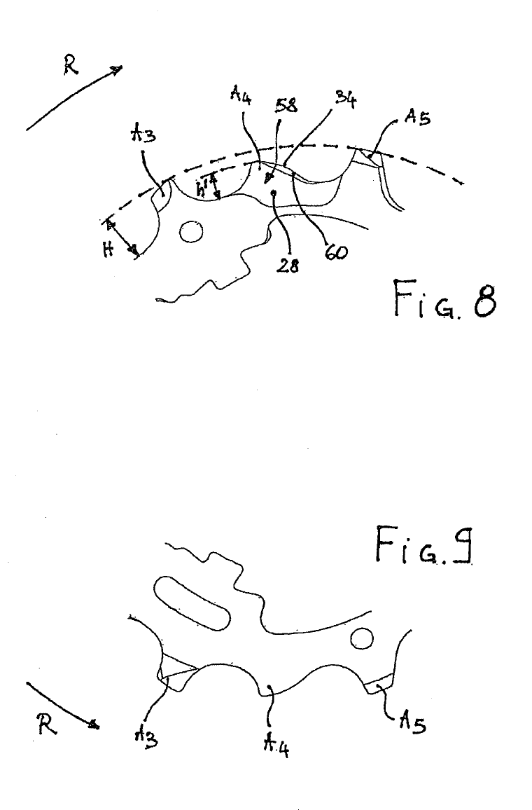

FIGS. 8 and 9 respectively show a front view and a rear view of the depressed tooth A4 of the upward gearshifting sector 18. The maximum height h′ of the tooth A4 is less than the maximum height H of the other teeth 11, 12, A1-A6. The highest part of the tooth A4 is the one closest to the following tooth A3. Moreover, the maximum height h′ of the depressed tooth A4 is preferably greater than or equal to 90% of the radius of the pin 52, i.e.

h′≧0.9*(d/2),

where d is the standard diameter of the pin 52 of the chain 15 (FIG. 7).

The following flank 30 of the depressed tooth A4 is defined by a concave surface suitable for coupling with the pin 52 of the chain 15. The tooth A4 may comprise a narrowing 58 on the outer face 28. The edge between the outer face 28 and the top face 34 is removed with a bevel 60. FIG. 1 shows the center of curvature O2 of the groove between the teeth A4 and A5 of the sprocket having smaller diameter 5, i.e. the center of curvature O2 of the groove preceding the tooth A4 of the sprocket 5, and the center of curvature O1 of the groove between the teeth A3 and A4 of the sprocket having larger diameter 10, i.e. the center of curvature O1 of the groove following the tooth A4 of the sprocket 10.

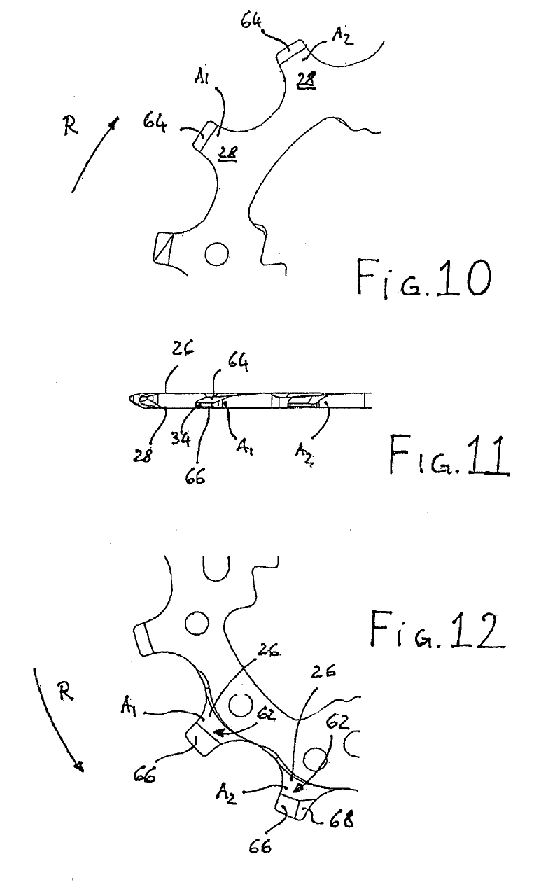

FIGS. 10, 11 and 12 are respective front, plan and rear views of further auxiliary teeth A1, A2 of the upward gearshifting sector 18 of the group of sprockets 1 of FIG. 1. The auxiliary teeth A1 and A2 are almost identical to one another and when they are located on the sprocket having larger diameter 10 they have the task of receiving the chain 15 during gearshifting.

Before gearshifting is complete, the chain 15 is not yet completely parallel to the sprockets 5, 10. In order to avoid harmful mechanical interference, both of the teeth A1 and A2 have a narrowing 62 on the inner face 26. The top portion of the teeth A1 and A2 is tapered on the outer face 28, where a bevel 64 is formed facing in the radial direction, which is substantially rectangular. On the inner face 26 there is a rhomboidal bevel 66, facing towards the preceding top end of the tooth. The tooth A2 comprises a further top bevel 68 that extends forwards with respect to the direction of rotation R and increases the depth of the tapering bevel 66.

In the embodiment in FIG. 11 the depth of the bevels on the inner and outer faces 26, 28 is such that the top face 34 of the teeth A1 and A2 is moved farther towards the outer face 28. This characteristic also promotes the engagement of the chain 15 when, during gearshifting, it is not yet perfectly aligned with the arrival sprocket 10.

The special shape of the teeth A1 and A2, described above and shown in the FIGS., facilitates the engagement of the chain 15 by the sprocket 10 and also reduces sprocket weight.

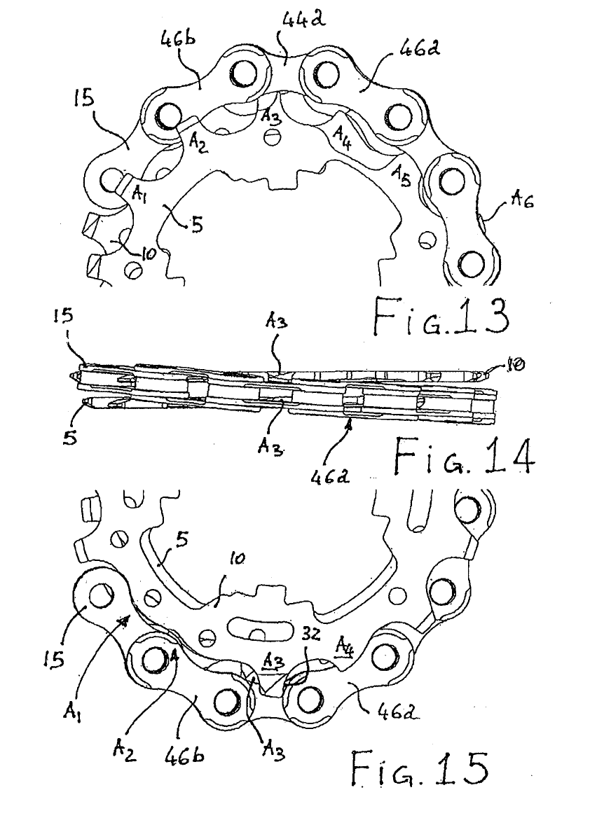

FIGS. 13, 14 and 15 illustrate the operation of the group of sprockets 1, during outer link gearshifting. The outer link 46a is the first to disengage the sprocket having a smaller diameter 5. The inner link 44a passes over the gearshifting helping tooth A3 without interfering with it; the tooth A3 on the other hand provides a support for the outer link 46b, which is thus already situated at the height of the sprocket having larger diameter 10.

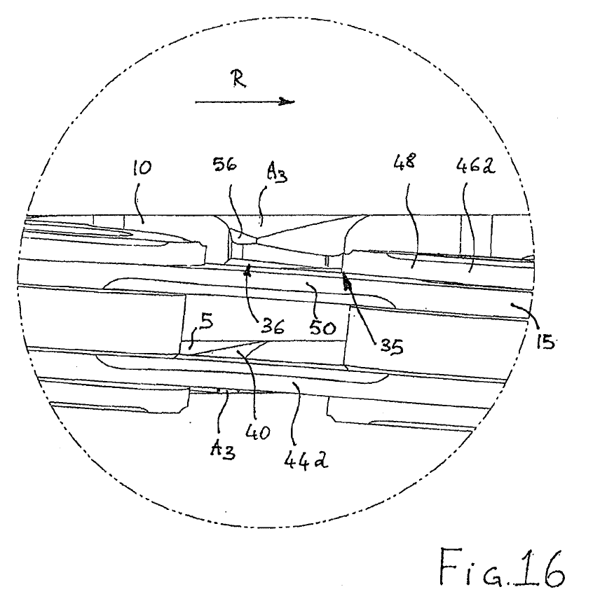

FIG. 16 shows in detail, and with an enlarged scale with respect to FIG. 14, the inner link 44a at the moment when it is located exactly above the gearshifting helping tooth A3 of the sprocket having smaller diameter 5. The plate 48 of the outer link 46a is hooked by the edge 35 of the tooth A3 of the sprocket having larger diameter 10 (the edge 35 goes into abutment against the link 46a, pulling it). Thanks to this hooking effect, the chain 15 is immediately pulled towards the sprocket having larger diameter 10.

Going back to FIG. 15, it can be seen that the preceding flank 32 of the tooth A3 of the sprocket having larger diameter 10, and in particular its lifting edge 35, provides a support for the outer link 46a and causes it to be lifted from the sprocket having smaller diameter 5, in the radial direction. A plate 50 of the inner link 44a moves at the side of the tooth A3 of the sprocket 10 without interfering with it, thanks to the presence of the concave bevel 36.

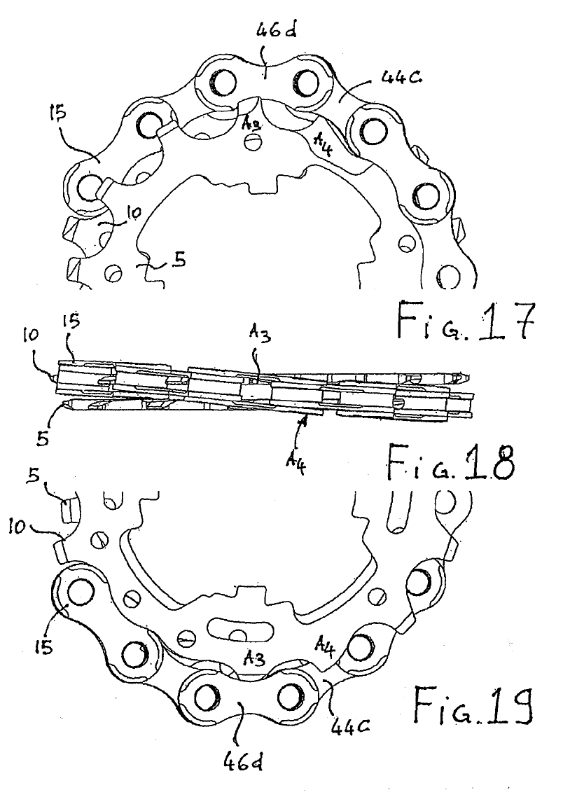

FIGS. 17, 18 and 19 illustrate the operation of the group of sprockets 1, during inner link gearshifting. The first link of the chain 15 that disengages the sprocket 5 is the inner link 44c, which passes over the depressed tooth A4, resting upon it.

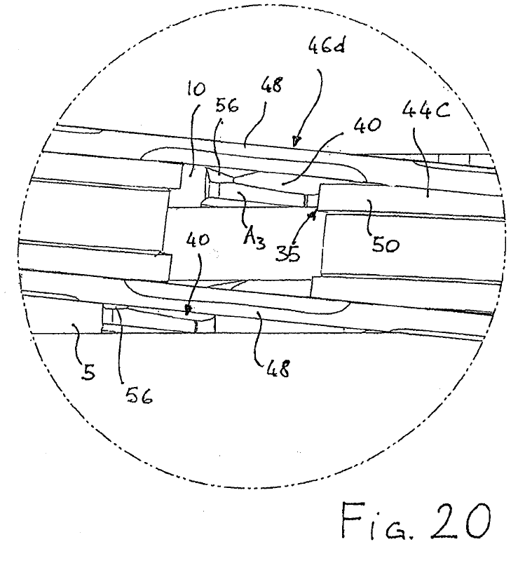

The action of the tooth A3 of the sprocket 10 is illustrated in detail and in enlarged scale in FIG. 20. The hooking edge 35 goes into abutment against the plate 50 of the inner link 44c. The preceding flank 32 of the tooth A3 of the sprocket 10 provides a support for the inner link 44c of the chain 15 and causes it to be lifted from the sprocket 5, in the radial direction (not shown).

The plates 48 of the outer link 46d do not interfere with the teeth A3 of the two sprockets 5 and 10 thanks to the presence of the triangular bevels 40. The presence of the bevel 56 further contributes to preventing interference.

In the group of sprockets 1, both in the case of inner link gearshifting and in the case of outer link gearshifting, the edge 35 of the tooth A3 acts as hooking edge of the pin 52 and the preceding flank 32 acts as support surface for lifting the links. Alternatively, the perimeter edge of the outer face 28 of the tooth A3 can be configured as a hooking edge.

Preferably the sprockets 5 and 10 are identical in the shape of the teeth 11, 12. In this way, both of the sprockets 5 and 10 can act as a sprocket having smaller diameter or as a sprocket having larger diameter in a group containing more than two sprockets. It shall be clear to the person skilled in the art that, in this circumstance, the sprocket with minimum diameter of a group of sprockets 1 can lack the characteristics to be used for downward gearshifting and the sprocket with maximum diameter can lack the characteristics to be used for upward gearshifting. Moreover, wishing to allow the group 1 exclusively inner link gearshifting, the relative sprockets 5, 10, etc. can lack the characteristics to be used for outer link gearshifting, and vice-versa.

The sprocket and the group of sprockets 1 allow quick and precise gearshifting, with minimum risk of interruption in the transmission of torque to the rear wheel of the bicycle. The portion of chain 15 that is moved onto the sprocket having larger diameter 10 is immediately in phase with the teeth A1-A6 of such a sprocket and can immediately transmit torque without idling of the group 1.

What is claimed is:

1. Toothed wheel for a chain transmission system for a bicycle, intended to be coupled with at least one other toothed wheel in a group of toothed wheels rotating as a unit, comprising a plurality of teeth that follow one another on the radially outer periphery of the toothed wheel, alternating with grooves, wherein each tooth has a thickness, a width, and a height and has an idle flank, passive in transmission of torque with a bicycle chain, and a pressure flank, active in the transmission of torque with the chain, in which the pressure flank, which extends in circumferential direction, is concave for engagement with a pin of the chain, wherein the toothed wheel comprises at least one tooth for helping gearshifting the height of which, measured from the bottom of an adjacent groove, decreases in a direction of the pressure flank and is greater than or equal to 90% of the radius of the pin.

2. Toothed wheel according to claim 1, wherein the tooth for helping gearshifting also comprises a convex top face, which extends in the circumferential direction between an edge, or a vertex, at a maximum of the height and an edge, or a joining surface with the pressure flank, at a minimum of the height.

3. Toothed wheel according to claim 1, wherein the minimum height of the tooth for helping gearshifting, measured from the bottom of the groove adjacent to the pressure flank of the tooth itself, is greater than or equal to 90% of the radius of the pin of the chain.

4. Toothed wheel according to claim 1, wherein the tooth for helping gearshifting also comprises an outer face, perpendicular to an axis of the toothed wheel and facing towards a toothed wheel having smaller diameter, which forms with the idle flank a hooking edge of the chain.

5. Toothed wheel according to claim 2, wherein the tooth for helping gearshifting has a maximum height, measured with respect to the bottom of the groove adjacent to the pressure flank, at the intersection between the idle flank, the top face and an outer face.

6. Toothed wheel according to claim 5, wherein the minimum height of the tooth for helping gearshifting, measured from the bottom of the groove, is greater than or equal to ⅔ of the maximum height of the same tooth, measured from the bottom of the same groove.

7. Toothed wheel according to claim 4, wherein the tooth for helping gearshifting also comprises a first bevel formed on the outer face between the top face and the pressure flank, in which a depth of the first bevel with respect to the outer face increases towards the pressure flank, and is at its maximum at the join or the edge between the pressure flank and the top face.

8. Toothed wheel according to claim 7, wherein the first bevel is defined by a concave surface.

9. Toothed wheel according to claim 4, wherein the tooth for helping gearshifting also comprises an inner face, opposite the outer face and tapered in the radial direction to form a taper, on which a second bevel is formed that extends up to the idle vertex formed by the intersection between the inner face, the top face and the idle flank.

10. Toothed wheel according to claim 9, wherein the second bevel is defined by a flat triangular surface.

11. Toothed wheel according to claim 9, wherein on the taper a third bevel is formed that extends up to the point of intersecting the pressure flank.

12. Toothed wheel according to claim 11, wherein the second bevel and the third bevel intersect one another and intersect the taper and the top face, which do not intersect one another.

13. Toothed wheel according to claim 1, wherein the tooth for helping gearshifting is flanked, on a side of the idle flank, by a depressed tooth the maximum height of which is less than the maximum height of the remaining teeth of the same toothed wheel and a highest portion of which is proximal to the tooth for helping gearshifting.

14. Toothed wheel according to claim 1, wherein the toothed wheel is a sprocket.

15. Group of toothed wheels for a chain transmission system of a bicycle, comprising at least one toothed wheel having smaller diameter and at least one toothed wheel having larger diameter, fixed with respect to one another and rotatable around a common axis, intended to be selectively engaged by a transmission chain,
wherein the toothed wheels comprise, on their own periphery, a plurality of teeth arranged circumferentially and alternating with grooves, each tooth having a thickness, a width and a height and having an idle flank, passive in transmission of torque with the transmission chain, and a pressure flank, active in the transmission of torque with the transmission chain,
wherein the toothed wheel having larger diameter comprises at least one hooking tooth of the transmission chain, suitable for engaging and holding a portion of the transmission chain that, during gearshifting, extends between the toothed wheel having smaller diameter and the toothed wheel having larger diameter in a circular sector of the group of toothed wheels, defined as gearshifting sector, and
wherein in the gearshifting sector, a distance between a center of a groove between two consecutive teeth of the toothed wheel having smaller diameter and the center of a groove between two consecutive teeth of the toothed wheel having larger diameter is within the range:
0.85·N·P≦D≦N·P,
in which N is an integer number and P is the pitch of the group of toothed wheels.

16. Group of toothed wheels according to claim 15, wherein 0.85·N·P≦D≦0.95·N·P.

17. Group of toothed wheels according to claim 15, wherein N=2.

18. Group of toothed wheels according to claim 15, wherein the toothed wheel having larger diameter has one extra tooth compared to the toothed wheel having smaller diameter.

19. Group of toothed wheels according to claim 15, wherein at least the toothed wheel having smaller diameter comprises at least one tooth for helping gearshifting the height of which, measured from the bottom of the groove adjacent to the pressure flank, decreases in a direction of the pressure flank.

20. Group of toothed wheels according to claim 19, wherein the height of the tooth is greater than or equal to 90% of the radius of the pin of the transmission chain.

21. Group of toothed wheels according to claim 19, wherein the tooth for helping gearshifting also comprises a convex top face, which extends in a circumferential direction between an edge, or a vertex, having maximum height and an edge, or a joining surface with the pressure flank, having minimum height.

22. Group of toothed wheels according to claim 21, wherein the minimum height of the tooth for helping gearshifting, measured between the bottom of the groove adjacent to the pressure flank of the tooth itself and the intersection of the top surface with the pressure flank, is greater than or equal to 90% of the radius of the pin of the transmission chain.

23. Group of toothed wheels according to claim 15, wherein the hooking tooth also comprises an outer face, perpendicular to an axis of the toothed wheels and facing towards the toothed wheel having smaller diameter, which forms, with the idle flank, a hooking edge of the transmission chain.

24. Group of toothed wheels according to claim 23, wherein the hooking tooth also comprises a first bevel formed on the outer face between the top face and the pressure flank, in which a depth of the first bevel with respect to the outer face increases towards the pressure flank, and is at its maximum at the join or the edge between the pressure flank and the top face.

25. Group of toothed wheels according to claim 24, wherein the first bevel is defined by a concave surface.

26. Group of toothed wheels according to claim 19, wherein the tooth for helping gearshifting has a maximum height, measured with respect to the bottom of the groove adjacent to the pressure flank of the tooth itself, at the intersection between the idle flank and the top face.

27. Group of toothed wheels according to claim 26, wherein the minimum height of the tooth for helping gearshifting, measured from the bottom of the groove, is greater than or equal to ⅔ of the maximum height of the same tooth.

28. Group of toothed wheels according to claim 19, wherein, in the gearshifting sector, the hooking tooth of the toothed wheel having larger diameter is adjacent to the idle flank of the tooth for helping gearshifting of the toothed wheel having smaller diameter.

29. Group of toothed wheels according to claim 19, wherein the hooking tooth of the toothed wheel having larger diameter is identical to the tooth for helping gearshifting of the toothed wheel having smaller diameter.

30. Group of toothed wheels according to claim 19, wherein the tooth for helping gearshifting also comprises an inner face, perpendicular to an axis of the toothed wheels and facing towards the toothed wheel having larger diameter, tapered in the radial direction, on which a second bevel is formed that extends up to the idle vertex formed by the intersection between the inner face, the top face and the idle flank.

31. Group of toothed wheels according to claim 30, wherein the second bevel is defined by a flat triangular surface.

32. Group of toothed wheels according to claim 15, wherein the toothed wheel having smaller diameter comprises a depressed tooth the maximum height of which is smaller than the maximum height of the remaining teeth of the same toothed wheel.

33. Group of toothed wheels according to claim 32,
wherein at least the toothed wheel having smaller diameter comprises at least one tooth for helping gearshifting the height of which, measured from the bottom of the groove adjacent to the pressure flank, decreases in a direction of the pressure flank, wherein the depressed tooth is beside the idle flank of the tooth for helping gearshifting, and in that a highest portion of the depressed tooth is adjacent to the tooth for helping gearshifting.

34. Group of toothed wheels according to claim 32, wherein the tooth for helping gearshifting also comprises an inner face, perpendicular to an axis of the toothed wheels and facing towards the toothed wheel having larger diameter, tapered in the radial direction to form a taper, on which a second bevel is formed that extends up to the idle vertex formed by the intersection between the inner face, the top face and the idle flank, wherein on the taper a third bevel is formed that extends until it intersects the pressure flank.

35. Group of toothed wheels according to claim 34, wherein the second bevel and the third bevel intersect one another and intersect the taper and the top face, which do not intersect one another.

36. Group of toothed wheels according to claim 30, wherein the distance is calculated between the center of the groove adjacent to the idle flank of the hooking tooth of the toothed wheel having larger diameter and the center of the groove adjacent to the idle flank of a depressed tooth of the toothed wheel having smaller diameter.

37. Group of toothed wheels according to claim 15, wherein the tooth adjacent to the idle flank of the hooking tooth of the toothed wheel having larger diameter is provided having narrowing at the outer face, orientated perpendicular to the rotation axis and facing towards the toothed wheel having smaller diameter.

38. Group of toothed wheels according to claim 15, wherein the toothed wheels are sprockets.

39. A group of toothed wheels for a chain transmission system of a bicycle, comprising:
at least one toothed wheel having smaller diameter and at least one toothed wheel having larger diameter, fixed with respect to one another and rotatable around a common axis;
wherein the toothed wheels comprise, on their own periphery, a plurality of teeth arranged circumferentially and alternating with grooves, each tooth having a thickness, a width, and a height and having an idle flank, passive in transmission of torque with a chain, and a pressure flank, active in the transmission of torque with the chain,
wherein the toothed wheel having larger diameter comprises at least one hooking tooth of the chain hat, during gearshifting, extends between the toothed wheel having smaller diameter and the toothed wheel having larger diameter in a gearshifting sector of the group of toothed wheels,
wherein in the gearshifting sector, a distance between a center of a groove between two consecutive teeth of the toothed wheel having smaller diameter and the center of a groove between two consecutive teeth of the toothed wheel having larger diameter is within the range:
0.85·N·P≦D≦N·P,
in which N=an integer and P is the pitch of the group of toothed wheels,
wherein at least the toothed wheel having smaller diameter comprises at least one tooth with a height measured from the bottom of the groove adjacent to the pressure flank that decreases in a direction of the pressure flank.

40. The group of toothed wheels of claim 39, wherein N=2.

41. A smaller toothed wheel intended to be coupled with at least one other toothed wheel in a group of toothed wheels rotating as a unit, comprising:
a plurality of teeth that follow one another on the radially outer periphery of the toothed wheel, alternating with grooves, wherein each tooth has a thickness, a width, and a height, and has an idle flank, passive in transmission of torque with a transmission chain, and a pressure flank, active in the transmission of torque with the chain, in which the pressure flank, which extends in circumferential direction, has a concave portion with respect to an axis of the toothed wheel, and engages a pin of the chain in the concave portion, wherein the toothed wheel comprises at least one tooth for helping gearshifting the height of which, measured from the bottom of an adjacent groove, decreases in a direction of the pressure flank and is greater than or equal to 90% of the radius of the pin,
wherein the toothed wheel having smaller diameter comprises a depressed tooth, the maximum height of which is smaller than the maximum height of the remaining teeth of the same toothed wheel.

42. A group of toothed wheels for a chain transmission system of a bicycle, comprising:
at least one toothed wheel having smaller diameter and at least one toothed wheel having larger diameter, fixed with respect to one another and rotatable around a common axis;
wherein the toothed wheels comprise, on their own periphery, a plurality of teeth arranged circumferentially and alternating with grooves, each tooth having a thickness, a width, and a height and having an idle flank, passive in transmission of torque with a chain, and a pressure flank, active in the transmission of torque with the chain,
wherein the toothed wheel having larger diameter comprises at least one hooking tooth of the chain that, during gearshifting, extends between the toothed wheel having smaller diameter and the toothed wheel having larger diameter in a gearshifting sector of the group of toothed wheels,
wherein in the gearshifting sector, a distance between a center of a groove between two consecutive teeth of the toothed wheel having smaller diameter and the center of a groove between two consecutive teeth of the toothed wheel having larger diameter is within the range:
0.85·N·P≦D≦N·P,
in which N=2 and P is the pitch of the group of toothed wheels,
wherein at least the toothed wheel having smaller diameter comprises at least one tooth with a height measured from the bottom of the groove adjacent to the pressure flank that decreases in a direction of the pressure flank,
wherein the toothed wheel having smaller diameter comprises a depressed tooth, the maximum height of which is smaller than the maximum height of the remaining teeth of the same toothed wheel
wherein at least the toothed wheel having smaller diameter comprises at least one tooth for helping gearshifting the height of which, measured from the bottom of the groove adjacent to the pressure flank, decreases in a direction of the pressure flank, wherein the depressed tooth is beside the idle flank of the tooth for helping gearshifting, and in that a highest portion of the depressed tooth is adjacent to the tooth for helping gearshifting.

43. A wheel in a group of toothed wheels, the wheel comprising teeth separated by grooves that are convex to an axis of the wheel, wherein each tooth has a height measured from a centerpoint of the groove to a tooth portion concave to the axis, wherein the toothed wheel comprises at least one tooth with a height along the tooth portion that decreases along a length thereof, and is greater than or equal to 90% of the radius of a pin that joins links in a bicycle transmission chain.

44. A group of toothed wheels for a chain transmission system of a bicycle, comprising:
at least one toothed wheel having smaller diameter and at least one toothed wheel having larger diameter, fixed with respect to one another and rotatable around a common axis;
wherein the toothed wheels comprise, on their own periphery, a plurality of teeth arranged circumferentially and alternating with grooves, each tooth having a thickness, a width, and a height and having an idle flank, passive in transmission of torque with a chain, and a pressure flank, active in the transmission of torque with the chain, in which the pressure flank, which extends in circumferential direction, has a concave portion with respect to an axis of the toothed wheel, and engages a pin of the chain in the concave portion,
wherein the toothed wheel having smaller diameter comprises at least one tooth for helping gearshifting the height of which, measured from the bottom of an adjacent groove, decreases in a direction of the pressure flank and is greater than or equal to 90% of the radius of the pin,
wherein the toothed wheel having smaller diameter comprises a depressed tooth, the maximum height of which is smaller than the maximum height of the remaining teeth of the same toothed wheel.
